(19) United States
(12) Patent Application Publication
(10) Pub. No.: US 2019/0027000 A1
(43) Pub. Date: Jan. 24, 2019

(54) Interactive Alert Notification System

(71) Applicant: KOVACORP, Manahawkin, NJ (US)

(72) Inventor: CHRISTOPHER ANTHONY SILVA, FAIR HAVEN, NJ (US)

(21) Appl. No.: 16/039,414

(22) Filed: Jul. 19, 2018

Related U.S. Application Data
(60) Provisional application No. 62/534,318, filed on Jul. 19, 2017.

(51) Int. Cl. G08B 3/10; G06F 3/0481

(52) U.S. Cl. CPC G08B 3/10; G06F 3/04817

(57) ABSTRACT

An alert notification system to automatically receive, store and play alerts. The alerts can be generated by a user. For example, the alerts can be generated by a public emergency system or a corporate system. An introductory tone can be generated by the system to advise that an alert message has been received. The alerts can be generated by a user. For example, the alerts can be generated by a public emergency system or a corporate system. An introductory tone can be generated by the system to advise that an alert message has been received. After the introductory tone is played, an audible alert message can be played in real time. The received alert message can be played over again one or more times. The system can include an interactive user display. The interactive display can include a screen to display actions which can be taken by the user. In one embodiment, the display can be activated to allow a user to review and play the last alert message, review and play the second alert or to acknowledge that the alert has been reviewed.

### BACKGROUND OF THE INVENTION

### Field of the Invention

The present invention relates to an interactive alert notification system to receive, store and play alerts.

### Description of Related Art

Emergency alert systems are known. Conventional emergency alert systems include the emergency broadcast system which broadcasts alerts on television and the radio. Automated telephone calling systems are also used for sending alert messages.

U.S. Pat. No. 547,978 describes an emergency alert warning system which employs a geographic area message, which is based on a particular geographic area within which all persons should receive the emergency alert message. The invention utilizes an emergency alert enabled device that receives both the emergency alert message and the geographic area message. The emergency alert enabled device determines whether it is located within the geographic area of concern, and if so, presents the emergency alert message to the end user. The emergency alert enabled device can be embedded within a cell phone, automobile stereo or navigation systems and televisions.

It is desirable to provide a dedicated interactive alert system to receive, store and play alerts.

### SUMMARY OF THE INVENTION

The present invention relates to an alert notification system and method that can automatically receive, store and play alerts. The alerts can be generated by a user. For example, the alerts can be generated by a public emergency system or a corporate system. An introductory tone can be generated by the system to advise that an alert message has been received. After the introductory tone is played, an audible alert message will play in real time. The received alert message can be played over again one or more times. The system can also receive a roll call. The alert message can be played by a speaker of the alert notification system.

The system can include visual indicators to visually indicate that an alert message has been received. In one embodiment, the visual indicator is an indicator light. The indicator light can flash when the alert message has been received. The alert message can be stored in the alert notification system.

The system can include an interactive user display. The interactive display can include a screen to display actions which can be taken by the user. In one embodiment, the display can be activated to allow a user to review and play the last alert message, review and play the second alert or to acknowledge that the alert has been reviewed. The display can also be activated to allow a user to scroll through the stored alerts and select one or more of the stored alerts to be played back. The display can include a hang up activation button to end an alert message playback or a roll call.

The invention will be more fully described by reference to the following drawing.

### BRIEF DESCRIPTION OF THE DRAWING

FIG. 1 is a schematic diagram of an alert notification system in accordance with the teachings of the present invention.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

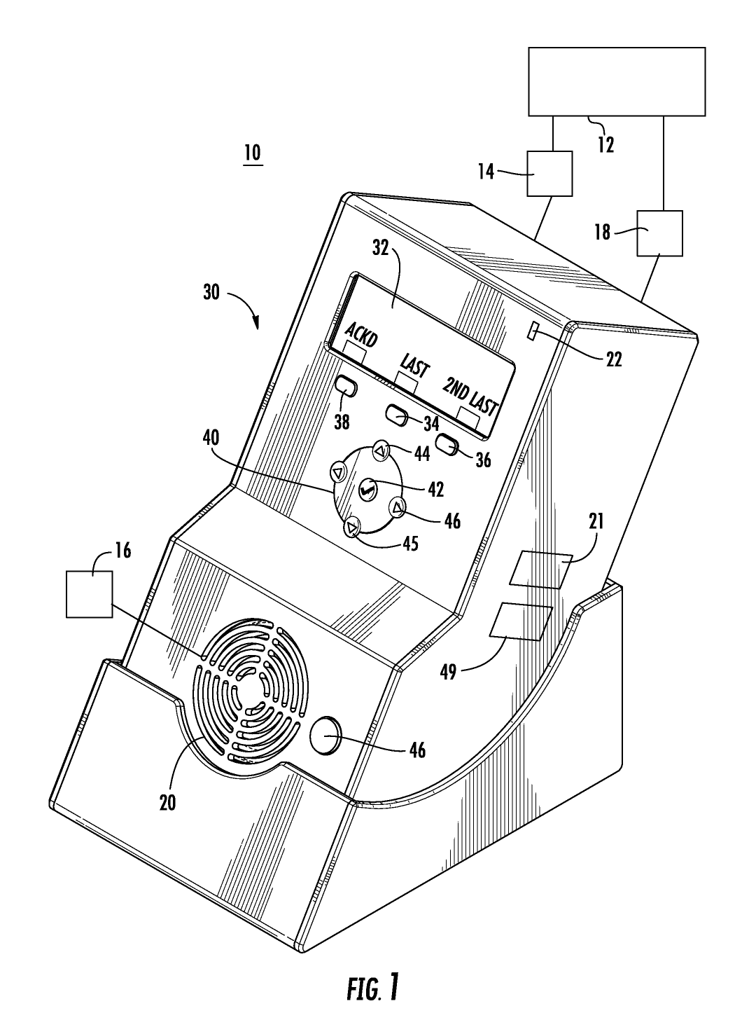

FIG. 1 illustrates alert notification system 10. Alert notification system 10 can automatically receive and play alerts. Central system 12 generates an alert message 14. For example, central system 12 can be a public emergency system or a corporate system. Central system 12 forwards alert message 14 to interactive user display 30. In one embodiment, central system 12 forwards alert message 14 over an intranet or a dedicated transport medium.

Interactive user display 30 can play introductory tone 16 by speaker 20 to advise that an alert message has been received. For example, introductory tone 16 can be a 1.5 second warble tone. After introductory tone 16 is played, alert message 14 can be played by speaker 20 in real time. Alert message 14 can be played over again one or more times. In one embodiment, when the alert is completed, alert message 14 will play back in its entirety without introductory tone 16 for two times.

Alert notification system 10 can also receive a roll call message 18. Alert message 14 and roll call message 18 can be played by speaker 20 of alert notification system 10. Alert message 14 and roll call message 18 can be stored in storage 21 of alert notification system 10.

Visual indicator 22 can visually indicate that alert message 14 has been received by interactive user display 30. Visual indicator 22 can be an indicator light. For example, visual indicator 22 can be a red light. Visual indicator 22 can flash when alert message 14 has been received.

Interactive user display 30 can include screen 32. Screen 32 can display actions which can be taken by the user. Buttons 34, 36 and 38 can be activated to perform the actions displayed on screen 32. In one embodiment, button 34 can be activated to allow a user to review and play the last alert message. Button 36 can be activated to allow a user to review and play the second alert. Button 38 can be activated to acknowledge that the alert has been reviewed.

Direction pad 40 can be activated to allow a user to scroll through the stored alert messages 14 and select one or more of the stored alert messages 14 to be played back. Center check mark 42 of direction pad 40 allows the user to choose which alert message 14 they would like to play back. Up arrow 44 allows a user to review and play a pre-determined number of alert messages 14. For example, the user can review and play the last 8 alert messages 14. Down arrow 45 allows a user to scroll through a pre-determined number of alert messages. For example, a user can scroll through the past 99 alert messages 14. Hang up activation button 46 can be activated to end playback of an alert message 14 or roll call message 18. Features of buttons 34, 36, 38, directional pad 40, interactive user display 30 and storage 21 can be implemented with processor 49. Processor 49 can include hardware of a printed circuit board used within interactive user display 30.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. An alert notification system comprising:
an interactive user display, the interactive display including a receiver for receiving an alert messages;
the interactive user display including a screen configured to display a first action of playing the received alert message; and
a first button, the first button being associated with the first action;
the interactive user display including a speaker,
wherein the first button being activated to play the received first alert message by the speaker.

2. The alert notification system of claim 1 wherein the screen is configured to display a second action of playing a previously received alert message and further comprising:
a second button, the second button being associated with the second action,
wherein the second button being activated to play the previously received alert message by the speaker.

3. The alert notification system of claim 1 wherein the screen is configured to display a third action of acknowledging that the received alert message has been received further comprising:
a third button, the third button being associated with the third action,
wherein the third button being activated to acknowledge that the received alert message has been played.

4. The alert notification system of claim 1 wherein the one or more alert messages are forward from a central server to the interactive user display.

5. The alert notification system of claim 4 wherein the one or more alert messages are forwarded over the internet.

6. The alert notification system of claim 1 wherein the interactive user display plays an introductory tone by the speaker to advise that the alert message has been received.

7. The alert notification system of claim 6 wherein after playing of the introductory tone, the alert is played in real time.

8. The alert notification system of claim 6 wherein the introductory tone is a warble tone.

9. The alert notification system of claim 1 wherein the previously received alert message is played over again one or more times.

10. The alert notification system of claim 1 wherein a roll call message is received at the interactive user display and is played by the speaker.

11. The alert notification system of claim 1 wherein further comprising an indicator, the indicator indicates that the alert message has been received by the interactive user display.

12. The alert notification system of claim 11 wherein the indicator is an indicator light, the indicator light emitting light when the alert message has been received.

13. The alert notification system of claim 11 wherein the indicator light flashes when the alert message has been received.

14. The alert notification system of claim 1 further comprising a direction pad, the direction pad including an up arrow to review and play a predetermined number of the alert messages.

15. The alert notification system of claim 1 further comprising a direction pad, the direction pad including a down arrow to scroll through a predetermined number of the alert messages.

16. The alert notification system of claim 1 wherein the interactive user display includes a processor, the processor receiving the alert message and configured to generate the display of the first action.

17. The alert notification system of claim 16 wherein the processor is configured to generate the display of the second action.

18. The alert notification system of claim 17 wherein the processor is configured to generate the display of the third action.
